(19) United States
(12) Patent Application Publication
(10) Pub. No.: US 2017/0188052 A1
(43) Pub. Date: Jun. 29, 2017

(54) VIDEO FORMAT DISCRIMINATING METHOD AND SYSTEM

(71) Applicants: Le Holdings (Beijing) Co., Ltd., Beijing (CN); Le Shi Zhi Xin Electronic Technology (Tianjin) Limited, Tianjin (CN)

(72) Inventor: Minglei Chu, Binhai New Area (CN)

(21) Appl. No.: 15/241,241

(22) Filed: Aug. 19, 2016

Related U.S. Application Data
(63) Continuation of application No. PCT/CN2016/089575, filed on Jul. 10, 2016.

(30) Foreign Application Priority Data
Dec. 27, 2015 (CN) 201511008035.0

(51) Int. Cl. H04N 19/70; H04N 19/167; H04N 19/136; G06K 9/46; G06K 9/52; H04N 19/17; G06K 9/62

(52) U.S. Cl. CPC H04N 19/70; H04N 19/17; H04N 19/167; G06K 9/6215; G06K 9/4652; G06K 9/52; H04N 19/136

(57) ABSTRACT

The present disclosure relates to the field of technologies for playing videos, and discloses a video format distinguishing method and an electronic device. In this disclosure, at least one video frame is selected from a video to be distinguished; the video frame is divided into a template selection area and a detection area, and at least one matching template is selected from the template selection area; a position having the highest similarity to the matching template in the detection area is acquired; and a format of the video to be distinguished is determined according to the acquired position. Using the embodiments of the present disclosure may automatically distinguish a video format, so as to avoid frequent participancy of users and improve user experience.

### CROSS-REFERENCE TO RELATED APPLICATIONS

The application is a continuation of PCT application No. PCT/CN2016/089575 submitted on Jul. 10, 2016, and the present disclosure claims priority to Chinese Patent Application No. 201511008035.0, filed on Dec. 27, 2015 and entitled “VIDEO FORMAT DISTINGUISHING METHOD AND SYSTEM”, which is incorporated herein by reference in its entirety.

### TECHNICAL FIELD

The disclosure relates to the field of technologies for playing videos, and in particular, to a video format distinguishing method and an electronic device.

### BACKGROUND

Along with the development of science and technology, increasingly more video display formats emerge, for example, common video, stereoscopic video, 360 video, and the like. For a stereoscopic video, in the manner of observing scenery with human eyes, two sets of movie cameras, which are disposed in parallel and respectively represent left and right eyes of a person, are utilized to synchronously film two pieces of movie pictures with slight horizontal parallax. Side-by-side is a widely applied format in the existing stereoscopic video. The height and width of the resolution of the pictures in the left and rights eyes are not changed, and the pictures are pressed into one frame picture and arranged in the sequence of the left and right. For a 360 video, a camera is utilized to take 360-degree pictures to obtain a collection of photos, and one panoramic picture is obtained via seamless processing by using professional software.

Because different videos need different playback settings and playback modes, a format of a film source to be played needs to be detected prior to playback. In a conventional distinguishing method, videos in different video formats are placed into different folders. During playback, different videos are distinguished by different folders. In this method, different videos need to be artificially placed into different folders, increasing participancy of users. Moreover, for videos in unknown formats need to be played, distinguished, and placed into different folders, increasing complexity of distinguishment.

### SUMMARY

An objective of this present disclosure is to provide a video format distinguishing method and an electronic device that can automatically distinguish video formats, to avoid frequent participancy of users and improve user experience.

According to a first aspect, an implementation manner of the present disclosure provides a video format distinguishing method, including the following steps: selecting at least one video frame from a video to be distinguished; dividing the video frame into a template selection area and a detection area, and selecting at least one matching template from the template selection area; acquiring a position having the highest similarity to the matching template in the detection area; and determining a format of the video to be distinguished according to the acquired position.

According to a second aspect, an implementation manner of this disclosure further provides a non-volatile computer storage medium, which stores computer executable instructions, where the computer executable instructions are used to execute any foregoing video distinguishing method of this disclosure.

According to a third aspect, an implementation manner of this disclosure further provides an electronic device, including: at least one processor; and a memory communicably connected with the at least one processor for storing instructions executable by the at least one processor, where execution of the instructions by the at least one processor causes the at least one processor to execute any foregoing video distinguishing method of this disclosure.

Relative to the prior art, in implementation manners of the present disclosure, multiple video frames may be automatically selected from a video to be distinguished, each of the selected video frames is divided into a template selection area and a detection area, and multiple matching templates are selected from the template selection area, then a positing having the highest similarity to contents of the matching templates in the detection area, and a format of the video to be distinguished is determined according to the acquired position. Because video frames of different video formats, for example, a common video, a side-by-side 3D video and a 360 panoramic video, have their respective features, that is, contents of a video frame of the common video have randomicity, contents of different areas of a video frame in the side-by-side 3D video frame have the feature of high similarity, and contents on both ends of a video frame of the 360 panoramic video have high similarity, a format of one video frame is effectively identified after comparing whether there is high similarity in contents of different areas in the video frame and position distribution features of areas having high similarity in this implementation manner. Therefore, the implementation manner of this disclosure may automatically identify a video format, so as to reduce frequent participancy of users and improve user experience when a video is played.

In an embodiment, after the step of selecting at least one matching template from the template selection area and before the step of acquiring a position having a highest similarity to the matching template in the detection area, the method further includes the following steps: determining whether differences in three color components RGB of pixels within an area of the matching template satisfies a preset condition; if yes, in the step of acquiring a position having a highest similarity to the matching template in the detection area, acquiring a position of a matching template that has the highest similarity and satisfies the preset condition in the detection area. In this way, the matching templates on which similarity detection is made satisfy the condition for distinguishing a video format by means of similarity, so as to improve accuracy of video format distinguishing.

In an embodiment, the step of acquiring a position having a highest similarity to the matching template in the detection area includes the following substeps: selecting at least one detection template from the detection area; calculating a covariance between the matching template and the detection template; and acquiring a position of a detection template corresponding to the minimum covariance as the position having the highest similarity to the matching template in the detection area.

In an embodiment, a quantity of matching templates selected from each video frame is M, and M is a natural number greater than or equal to 2; and in the step of recording a position of a detection template corresponding to the minimum covariance as the position having a highest similarity to the matching template in the detection area, a position of a detection template corresponding to the minimum covariance of the M matching templates is acquired.

In an embodiment, a position of the detection template is the position where the top left corner or the central point of the detection template lies.

In an embodiment, the width of the template selection area is less than half the width of the video frame, and the height of the template selection area is less than or equal to the height of the video frame; the width of the matching template is less than the width of the template selection area, and the height of the matching template is equivalent to the height of the template selection area. Therefore, a matching template having a suitable position and size may be selected, so as to quickly and accurately distinguish a video format.

In an embodiment, a quantity of the selected video frames is N, and N is a natural number that is greater than or equal to 2; the step of determining a format of the video to be distinguished according to the acquired position includes the following steps: performing statistics on the acquired positions in the N video frames, and determining a format of the video to be distinguished; and if similar contents of more than half the video frames in the N video frames are located in ends of the video frames, determining that the video to be distinguished is a 360 video; or if similar contents of more than half the video frames in the N video frames are located in middle of the video frames, determining that the video to be distinguished is a side-by-side stereoscopic video; otherwise, determining that the video to be distinguished is a common video. In this way, a video format may be accurately distinguished.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a video format distinguishing method according to a first implementation manner of the present disclosure;

FIG. 2 is a schematic diagram illustrating selection of a matching template according to the first implementation manner of the present disclosure;

FIG. 3 is a flowchart of a video format distinguishing method according to a second implementation manner of the present disclosure;

FIG. 4 is a structural block diagram of a video format distinguishing system according to a fourth implementation manner of the present disclosure; and

FIG. 5 is a structural block diagram of an electronic device according to a sixth implementation manner of this disclosure.

### DETAILED DESCRIPTION

To make the objective, technical solutions, and advantages of the present disclosure clearer, the following further describes implementation manners of the present disclosure in detail with reference to the accompanying drawings. A person of ordinary skill in the art may understand that technical details are described in the implementation manners of the present disclosure to make readers more easily understand the present disclosure. However, if the technical details and various changes and modifications on the basis of the following implementation manners are not described, the technical solution needing protection in the claims of the present disclosure may be implemented.

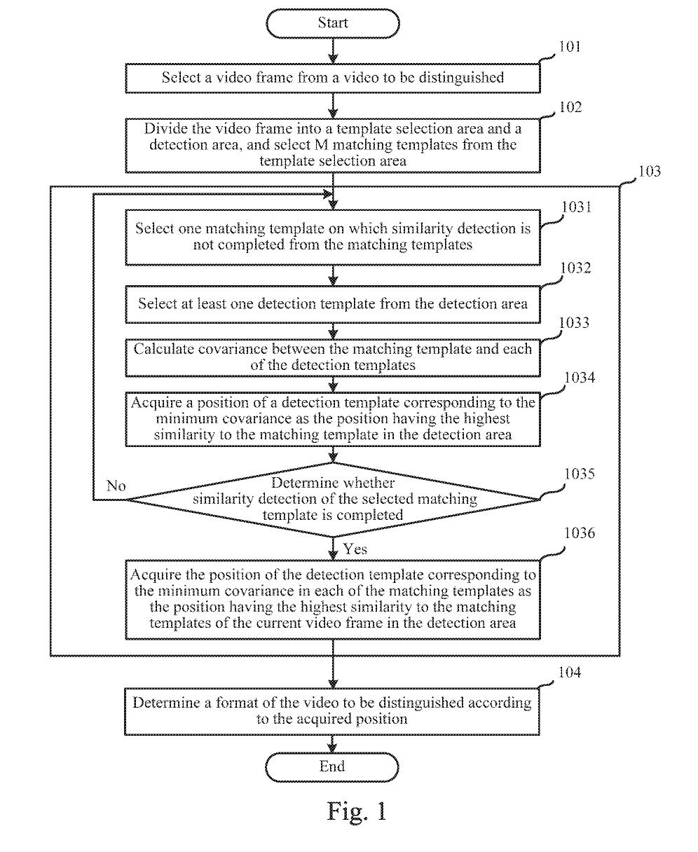

A first implementation manner of the present disclosure relates to a video format distinguishing method. Refer to FIG. 1 for the specific flow, and the method includes the following steps:

S101: Select a video frame from a video to be distinguished.

When a video is played, the video needing to be played is acquired, and a video frame is randomly selected from the acquired video. Because a data volume of one video frame is small, video format distinguishing may be completed more quickly.

S102: Divide the video frame into a template selection area and a detection area, and select M matching templates from the template selection area.

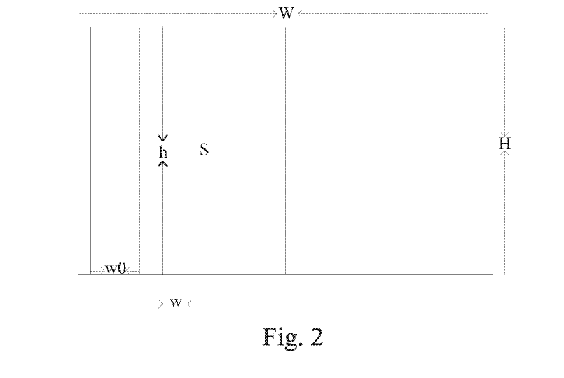

As shown in FIG. 2, the width of the video frame is W, and the height is H. An area S with limits at the left end of the video frame is selected as the template selection area, the width of S is w, and the height is h. In this implementation manner, the width of the template selection area is less than half the width of the video frame, and the height of the template selection area is less than or equal to the height of the video frame.

It should be noted that, template selection areas and detection areas are divided according to the principle of distribution features of figures having high similarity in different video frames. Therefore, when the figures having high similarity in a video frame are distributed up and down or distributed according to another rule, the template selection area may be flexibly divided. Specific division of the template selection area and the detection area is not limited in this implementation manner.

M the matching templates are selected from the template selection area S, where M is a natural number. That is, either only one matching template or multiple matching templates may be selected to achieve the objective of the present disclosure.

Specially, the height of each selected matching template is h, and the weight is w0, where w0<w, for example, w0=3.According to the matching templates of this implementation manner, for example, M matching templates T₁, T₂ . . . T_{M}, for convenient calculation, T₁, T₂ . . . T_{M} use the same width and height in this implementation manner. When the matching templates T₁, T₂ . . . T_{M} are selected, position P₁, P₂ . . . P_{M} of each matching templates may be recorded at the same time, and top left corners or central points of the matching templates may be used as the positions of the matching templates. It should be understood that the position of the matching template can represent an area of the video frame in which the matching template lies. Therefore, a recording mode of the position of the matching template is not specifically limited in this implementation manner.

By means of this step, multiple matching templates may be selected, and each of the matching templates is used as a part of image of the video frame. However, the multiple matching templates may cover the whole template selection area after they are connected to each other, and also may be most of the whole template selection area. Rules for selection of the matching templates are not limited in this implementation manner.

S103: Acquire a position having a highest similarity to the matching templates in the detection area.

After the matching templates are selected from the template selection area, the step for detecting the similarity specially includes the following substeps:

SS1031: Select one matching template on which similarity detection is not completed from the matching templates.

SS1032: Select at least one detection template from the detection area.

In this implementation manner, the template selection area S is located on the left half of the video frame, but the detection area is the remaining part except S. In this step, L detection templates are selected from the detection area of the video frame, where L is a natural number. Sizes of the detection templates are consistent with the matching template, and all the detection templates should cover the whole detection area after they are stitched with each other.

SS1033: Calculate covariance between the matching template and each of the detection templates.

Covariances between the matching template and the L detection templates are calculated, and covariance corresponding to each of the detection templates and positions of the detection templates are recorded, to obtain L covariances and positions of their corresponding detection templates, where a recording mode of the positions of the detection templates is the same as the recording mode of the positions of the matching template.

SS1034: Acquire a position of a detection template corresponding to the minimum covariance as the position having the highest similarity to the matching template in the detection area.

The minimum covariance is obtained after comparing L covariances, and the position of the detection template corresponding to the covariance value is recorded, to obtain the minimum covariance corresponding to a matching template and the position of the detection template.

SS1035: Determine whether similarity detection of the selected matching template is completed, if no, go back to execute SS1031; or if yes, execute SS1036.

SS1036: Acquire the position of the detection template corresponding to the minimum covariance in each of the matching templates as the position having the highest similarity to the matching templates of the current video frame in the detection area.

For the M matching templates, SS1031 to SS1035 are repeated to obtain minimum covariances corresponding to the M matching templates and positions of the detection templates. The minimum covariance is obtained after comparing the M covariances, and the position of the detection template corresponding to the covariance is recorded, that is, the position of the detection template corresponding to the minimum covariance of the matching templates is obtained and used as the position having the highest similarity to the matching templates of the current video frame in the detection area.

It should be noted that if one matching template is selected in S102, a position of a detection template corresponding to the minimum covariance of the matching template is used as the position having the highest similarity to the matching template in the detection area. In this way, the purpose of the present disclosure may also be achieved, and a quantity of the matching template is not limited in this implementation manner.

After acquiring the position having the highest similarity to the matching template in the detection area, S104 is executed, and a format of the video to be distinguished is determined according to the acquired position.

S104: Determine a format of the video to be distinguished according to the acquired position.

The specific determination method is: if a similar content of the selected video frame locates between (W-w, W), representing that the similar content of the video frame locates in the end of the video frame, therefore, it is determined that the video to be distinguished is a 360 video; if a similar content of the selected video frame locates between (W/2, W/2+w), representing that the similar content of the video frame locates in the middle of the video frame, therefore, it is determined that the video to be distinguished is a side-by-side stereoscopic video; if the video frame neither belongs to a 360 video nor belongs to a side-by-side stereoscopic video, it is determined that the video to be distinguished is a common video. However, this implementation manner is intended to put forward principles for determining a common video, a side-by-side video and a 360 video rather than a determining sequence. In actual application, a sequence for identifying a video format may be flexibly specified.

Compared with the prior art, according to this implementation manner, on the basis of the features of the common video, the 360 video and the side-by-side stereoscopic video, a position relation between the similar contents in the video frame of the video to be distinguished is compared, so as to quickly distinguish a video format of a video to be played. The whole process may be automatically completed without participancy of users, thereby reducing frequent participancy of users and improving user experience in watching videos.

A second implementation manner of the present disclosure relates to a video format distinguishing method. The second implementation manner is improved on the basis of the first implementation manner, and the main improvement is: in the second implementation manner, selecting multiple video frames from a video to be distinguished, calculating a position of a detection template of the minimum covariance among each of the video frame as the position having the highest similarity in the detection area, and determining a format of the video to be distinguished according to a position having the highest similarity in the multiple video frames. In this way, accuracy of video format distinguishing is improved by adding samples of sapling statistics.

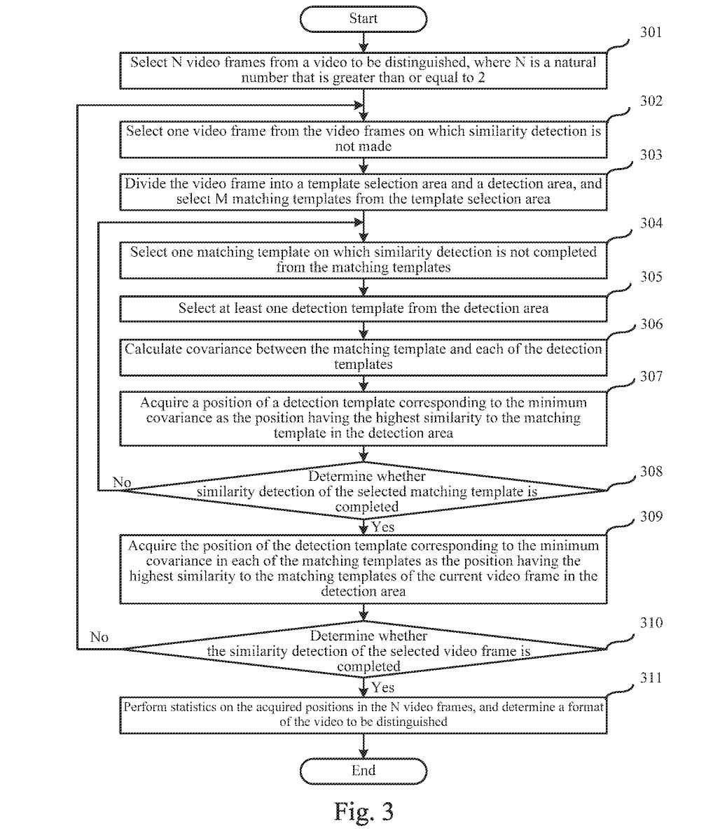

As shown in FIG. 3, the video format distinguishing method according to this implementation manner includes the following S301 to S311:

S301: Select N video frames from a video to be distinguished, where N is a natural number that is greater than or equal to 2.

It should be noted that if more video frames are selected, more statistical samples may be obtained, thereby improving accuracy of video identification; however, selecting more video frames must consume longer time for distinguishment, therefore, in this implementation manner, a value range of N is from 10 to 30, preferably, N is 20.

S302: Select one video frame from the video frames on which similarity detection is not made.

S303 is the same as S102 of the first implementation manner, and S304 to S309 are the same as S103 of the first implementation manner, so details are not described herein again.

S310: Determine whether the similarity detection of the selected video frame is completed, and if no, execute S302; or if yes, execute S311.

S311: Perform statistics on the acquired positions in the N video frames, and determine a format of the video to be distinguished.

The specific determination method is: if similar contents of more than half the video frames in the N video frames are located in ends of the video frames, determining that the video to be distinguished is a 360 video; or if similar contents of more than half the video frames in the N video frames are located in middle of the video frames, determining that the video to be distinguished is a side-by-side stereoscopic vide.

Now, an example is described as follows: for example, in S310, acquiring the positions P having the highest similarity to the matching templates of the N video frames in the detection area, Pi=1, 2. . . N, (where i represents a sequence number of the positions P, that is, the i^{th} position having the highest similarity), if among Pi, a quantity n of positions located in between (W-w, W) is greater than N/2, it can be seen that the positions of the similar contents of the video frames are located in the ends of the video frames, so the video to be distinguished is a 360 video; if among Pi, a quantity n of positions located in between (W/2, W/2+w) is greater than N/2, it can be seen that the positions of the similar contents of the video frames are located in the middle of the video frames, so the video to be distinguished is a side-by-side stereoscopic video. However, frame pictures of a common video have neither the feature of the 360 video nor the feature of the side-by-side stereoscopic video, so there is rarely similar content in its video frames. Therefore, after the 360 video and the side-by-side stereoscopic video are excluded, it is determined that the video to be distinguished is a common video.

A third implementation manner of the present disclosure relates to a video format distinguishing method. The third implementation manner is improved on the basis of the first or the second implementation manner, and the main improvement is: in the third implementation manner, performing filtering on matching templates to exclude a template that may cause a serious error, so as to improve a matching effect, thereby further ensuring accurately identifying a video format.

Specially, after the step of selecting at least one matching template from the template selection area, whether differences in three color components RGB of pixels within an area of each of the selected matching templates satisfies a preset condition is determined. If the preset condition is not satisfied, use of the matching template is given up; or if the preset condition is satisfied, the foregoing subsequent steps are executed. The preset condition may be that: a sum of standard deviations of the three color components RGB of pixels within the area of the matching template is greater than a preset threshold.

An example is described as follows: if colors of the selected matching templates are the same, for example, some film sources have black borders on left and rights sides, causing that all the selected matching templates may have black borders, so that different video formats cannot be distinguished according to the position having the highest similarity. Therefore, if pixels within an area of a matching template have the same color or similar colors, the matching template may be filtered by means of the following methods. For example, standard deviations of the color components RGB of the pixels within the area of the matching template are gained, for example, the three standard deviations are respectively DR, DG and DB, if the standard deviations are greater than a preset value, for example, DR+DG+DB>D, it is thought that the matching template may be used, otherwise, use of the matching template is given up. D herein may be obtained according to experiences or tests, and generally is 20.

The above methods are divided into steps for clear description. When the methods are achieved, the steps may be combined into one step or some steps may be divided into more steps, which shall fall within the protection scope of the present disclosure only if the steps include a same logic relation; the algorithm and flow to which inessential modification is made or inessential design is introduced without changing the core design of the algorithm and flow shall fall within the protection scope of the present disclosure.

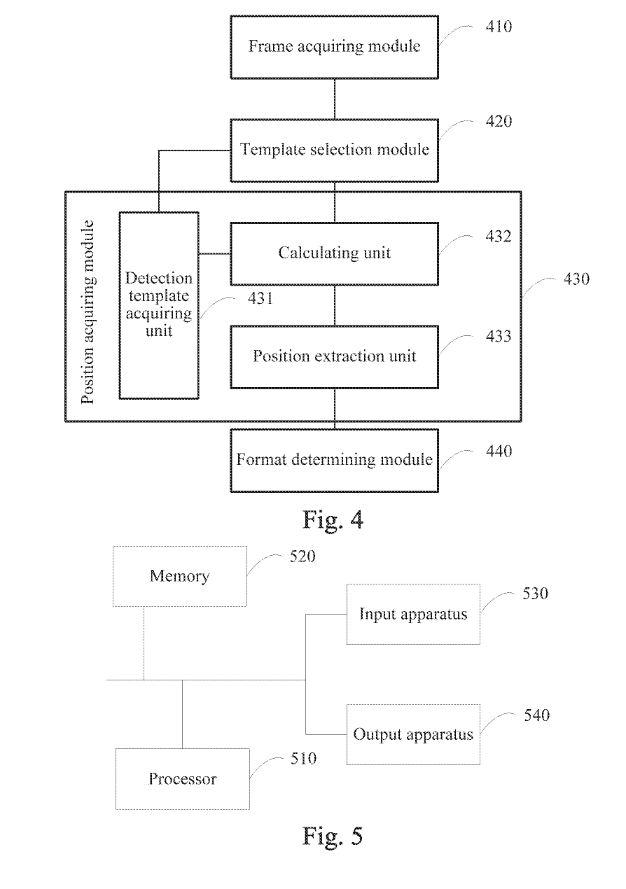

A fourth implementation manner of the present disclosure relates to a video format distinguishing system, as shown in FIG. 4, including: a frame acquiring module 410, a template selection module 420, a position acquiring module 430, and a format determining module 440.

The frame acquiring module 410 of this implementation manner is configured to select N video frames from a video to be distinguished, where N is a natural number. The template selection module 420 is configured to divide each of the video frames into a template selection area and a detection area, and select M matching templates from the template selection area.

The position acquiring module 430 further includes: a detection template acquiring unit 431, a calculating unit 432, and a position extraction unit 433. The position acquiring module 430 is configured to acquire a position having highest similarity to the matching templates in the detection area.

Specially, the detection template acquiring unit 431 is configured to respectively select L detection templates from detection areas of the matching templates, that is, the matching templates each correspond to L detection templates. The calculating unit 432 is configured to respectively calculate covariances between each of the matching templates and L detection templates, to obtain L covariances corresponding to each of the matching templates. The position extraction unit 433 is configured to extract a position of the detection template corresponding to the minimum covariance of the L covariances corresponding to each of the matching template in each of the video frames.

The format determining module 440 is configured to determine a format of the video to be distinguished according to the position of the detection template corresponding to the minimum covariance. The specific determination method is the same as that of the first implementation manner, the second implementation manner, or the third implementation manner, so details are not described herein again.

It is not difficult to find that this implementation manner is an embodiment of a system corresponding to the first implementation manner, and this implementation manner may be implemented in combination with the first implementation manner. Related technical details described in the first implementation manner are still effective in this implementation manner. To reduce duplication, the technical details are not described herein again. Correspondingly, related technical details described in this implementation manner may also be applied to the first implementation manner.

A fifth implementation manner of this disclosure provides a non-volatile computer storage medium, which stores computer executable instructions, where the computer executable instructions can execute the video format distinguishing method in the foregoing embodiments.

A sixth implementation manner of this disclosure provides an electronic device for executing a video format distinguishing method, and a schematic structural diagram of hardware is shown in FIG. 5. The device includes:

one or more processors 510 and a memory 520, where only one processor 510 is used as an example in FIG. 5.

A device for executing the video format distinguishing method may further include: an input apparatus 530 and an output apparatus 540.

The processor 510, the memory 520, the input apparatus 530, and the output apparatus 540 can be connected by means of a bus or in other manners. A connection by means of a bus is used as an example in FIG. 5.

As a non-volatile computer readable storage medium, the memory 520 can be used to store non-volatile software programs, non-volatile computer executable programs and modules, for example, program instructions/module corresponding to the video format distinguishing method in the embodiments of this disclosure (for example, the frame acquiring module 410, the template selection module 420, the position acquiring module 430, and the format determining module 440 shown in FIG. 4). The processor 510 executes various functional applications and data processing of the server, that is, implements the video format distinguishing method of the foregoing method embodiments, by running the non-volatile software programs, instructions, and modules that are stored in the memory 520.

The memory 520 may include a program storage area and a data storage area, where the program storage area may store an operating system and an application that is needed by at least one function; the data storage area may store data created according to use of a processing apparatus for distinguishing a video format, and the like. In addition, the memory 520 may include a high-speed random access memory, or may also include a non-volatile memory such as at least one disk storage device, flash storage device, or another non-volatile solid-state storage device. In some embodiments, the memory 520 optionally includes memories that are remotely disposed with respect to the processor 510, and the remote memories may be connected, via a network, to the processing apparatus for distinguishing a video format. Examples of the foregoing network include but are not limited to: the Internet, an intranet, a local area network, a mobile communications network, or a combination thereof.

The input apparatus 530 can receive an entered video to be distinguished, and generate key signal inputs relevant to user setting and functional control of the processing apparatus for distinguishing a video format. The output apparatus 540 may include a display device, for example, a display screen.

The one or more modules are stored in the memory 520; when the one or more modules are executed by the one or more processors 510, the video format distinguishing method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy, and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. Video format distinguishing method, comprising:
selecting at least one video frame from a video to be distinguished;
dividing the video frame into a template selection area and a detection area, and selecting at least one matching template from the template selection area;
acquiring a position having a highest similarity to the matching template in the detection area; and
determining a format of the video to be distinguished according to the acquired position.

2. The video format distinguishing method according to claim 1, wherein after the step of selecting at least one matching template from the template selection area and before the step of acquiring a position having a highest similarity to the matching template in the detection area, the method further comprises the following steps:
determining whether differences in three color components RGB of pixels within an area of the matching template satisfies a preset condition;
if yes, in the step of acquiring a position having a highest similarity to the matching template in the detection area, acquiring a position of a matching template that has the highest similarity and satisfies the preset condition in the detection area.

3. The video format distinguishing method according to claim 2, wherein the preset condition is:
a sum of standard deviations of the three color components RGB of pixels within the area of the matching template is greater than a preset threshold.

4. The video format distinguishing method according to claim 1, wherein the step of acquiring a position having a highest similarity to the matching template in the detection area comprises:
selecting at least one detection template from the detection area;
calculating a covariance between the matching template and the detection template; and
acquiring a position of a detection template corresponding to the minimum covariance as the position having the highest similarity to the matching template in the detection area.

5. The video format distinguishing method according to claim 4, wherein a quantity of matching templates selected from each video frame is M, and M is a natural number greater than or equal to 2;
in the step of recording a position of a detection template corresponding to the minimum covariance as the position having the highest similarity to the matching template in the detection area, acquiring a position of a detection template corresponding to the minimum covariance of the M matching templates.

6. The video format distinguishing method according to claim 4, wherein a position of the detection template is the position where the top left corner or the central point of the detection template lies.

7. The video format distinguishing method according to claim 1, wherein the width of the template selection area is less than half the width of the video frame, and the height of the template selection area is less than or equal to the height of the video frame;
the width of the matching template is less than the width of the template selection area, and the height of the matching template is equal to the height of the template selection area.

8. The video format distinguishing method according to claim 1, wherein after the step of selecting at least one matching template from the template selection area, a position having the highest similarity to the matching template in the detection area is acquired, and a position of the matching template when the similarity is highest.

9. The video format distinguishing method according to claim 1, wherein a quantity of the selected video frames is N, and N is a natural number that is greater than or equal to 2;
the step of determining a format of the video to be distinguished according to the acquired position comprises the following substeps:
performing statistics on the acquired positions in the N video frames, and determining a format of the video to be distinguished; and
if similar contents of more than half the video frames in the N video frames are located in ends of the video frames, determining that the video to be distinguished is a 360 video; or
if similar contents of more than half the video frames in the N video frames are located in middle of the video frames, determining that the video to be distinguished is a side-by-side stereoscopic video; or
otherwise, determining that the video to be distinguished is a common video.

10-11. (canceled)

12. A non-volatile computer storage medium, which stores computer executable instructions that, when executed by an electronic device, cause the electronic device to:
select at least one video frame from a video to be distinguished;
divide the video frame into a template selection area and a detection area, and selecting at least one matching template from the template selection area;
acquire a position having a highest similarity to the matching template in the detection area; and
determine a format of the video to be distinguished according to the acquired position.

13. The non-volatile computer storage medium according to claim 12, wherein after the instructions to select at least one matching template from the template selection area and before the step of acquiring a position having a highest similarity to the matching template in the detection area, the storage medium further cause the electronic device to:
determine whether differences in three color components RGB of pixels within an area of the matching template satisfies a preset condition;
if yes, in the step of acquiring a position having a highest similarity to the matching template in the detection area, acquire a position of a matching template that has the highest similarity and satisfies the preset condition in the detection area.

14. The non-volatile computer storage medium according to claim 13, wherein the preset condition is:
a sum of standard deviations of the three color components RGB of pixels within the area of the matching template is greater than a preset threshold.

15. The non-volatile computer storage medium according to claim 12, wherein the instructions to acquire a position having a highest similarity to the matching template in the detection area cause the electronic device to:
select at least one detection template from the detection area;
calculate a covariance between the matching template and the detection template; and
acquire a position of a detection template corresponding to the minimum covariance as the position having the highest similarity to the matching template in the detection area.

16. The non-volatile computer storage medium according to claim 15, wherein a quantity of matching templates selected from each video frame is M, and M is a natural number greater than or equal to 2;
in the step of recording a position of a detection template corresponding to the minimum covariance as the position having the highest similarity to the matching template in the detection area, acquiring a position of a detection template corresponding to the minimum covariance of the M matching templates.

17. An electronic device, comprising:
at least one processor, and
a memory in communication connection with the at least one processor, wherein
the memory stores instructions that can be executed by the at least one processor,
wherein execution of the instructions by the said at least one processor causes the at least one processor to:
select at least one video frame from a video to be distinguished;
divide the video frame into a template selection area and a detection area, and select at least one matching template from the template selection area;
acquire a position having a highest similarity to the matching template in the detection area; and
determine a format of the video to be distinguished according to the acquired position.

18. The electronic device according to claim 17, wherein after the execution of the instructions to select at least one matching template from the template selection area and before the step of acquiring a position having a highest similarity to the matching template in the detection area, the electronic device further cause the at least one processor to:
determine whether differences in three color components RGB of pixels within an area of the matching template satisfies a preset condition;
if yes, in the step of acquiring a position having a highest similarity to the matching template in the detection area, acquire a position of a matching template that has the highest similarity and satisfies the preset condition in the detection area.

19. The electronic device according to claim 18, wherein the preset condition is:
a sum of standard deviations of the three color components RGB of pixels within the area of the matching template is greater than a preset threshold.

20. The electronic device according to claim 17, wherein the execution of the instructions to acquire a position having a highest similarity to the matching template in the detection area cause the at least one processor to:
select at least one detection template from the detection area;
calculate a covariance between the matching template and the detection template; and
acquire a position of a detection template corresponding to the minimum covariance as the position having the highest similarity to the matching template in the detection area.

21. The electronic device according to claim 20, wherein a quantity of matching templates selected from each video frame is M, and M is a natural number greater than or equal to 2;
in the step of recording a position of a detection template corresponding to the minimum covariance as the position having the highest similarity to the matching template in the detection area, acquiring a position of a detection template corresponding to the minimum covariance of the M matching templates.

22. The electronic device according to claim 20, wherein a position of the detection template is the position where the top left corner or the central point of the detection template lies.
